(19) United States
(12) Patent Application Publication
(10) Pub. No.: US 2007/0140138 A1
(43) Pub. Date: Jun. 21, 2007

(54) Method and apparatus for use in an Internet Protocol (IP)-based device for providing a user with indications of conditions that may affect use of Internet services

(75) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/313,514

(22) Filed: Dec. 21, 2005

(51) Int. Cl. H04J 1/16

(52) U.S. Cl. 370/252

(57) ABSTRACT

A method and an apparatus for use in an IP-based device having at least one indicator that conveys information to a user as to conditions that may affect use of an IP service by a user of an IP-based device. Such information includes, for example, network component ports that are and are not open, IP addresses that are and are not available, call signaling anomalies, bandwidth availability, network congestion, packet loss, account status, etc.

### TECHNICAL FIELD OF THE INVENTION

The invention relates to Internet Protocol (IP)-based devices. More particularly, the invention relates to an IP-based device that has one or more indicators that indicate to the user information that is relevant to conditions that may affect use of one or more Internet services by a user of an IP-based device.

### BACKGROUND OF THE INVENTION

IP-based devices such as IP telephones, for example, are able to use IP services over networks that use the IP communications protocol. Such networks include the Internet, local area networks (LANs) and wide area networks (WANs), all of which use IP. Typical IP services include, for example, placing, receiving and participating in a voice call using an IP telephony system, receiving an audio file from a streaming audio server, receiving an audio/video (A/V) file from a streaming A/V server, downloading a text file from a server, sending and receiving email messages, performing searches using search engines, using a video telephony system, etc. In order for a user to be able to successfully use an IP service, various network components must be operating properly. In addition, there are components in the subscriber's premises that must be operating properly in order for the service to be used. If one or more of these components is not operating properly, the user will not be able to successfully use the service.

A variety of issues can arise that may prevent the user from using an IP service including, for example, problems with Internet connectivity, LAN connectivity, WAN connectivity, service connectivity and authentication, provisioning success, account activation status, network congestion, etc. One problem that often occurs when an IP-based device attempts to place a call is the inability to move data in and out of the router to which the IP-based device is connected in the subscriber's premises. Firewalls and IP network address translators (NATs) typically implemented in routers often create problems that prevent the user from using the service. Although routers and modems typically do have status indicators, these indicators only provide the user with link-level information, and provide no information as to whether the user can expect to reliably use a service.

In addition, IP-based devices often require the use of multiple communications protocols in order to use an IP service, which sometimes creates problems at the Internet Service Provider (ISP) that may prevent the user from using the service. Other issues such as quality of service (QoS) issues (e.g., congestion, bandwidth availability, packet misordering, etc.) may also prevent use of a service. Also, ports and network addresses that a service might require are sometimes unavailable, which can prevent a user from using the service. Furthermore, even if all of the components that a service needs are operating properly, account status can prevent the user from using the service. For example, if the user is no longer an authorized subscriber due to failure to make payment, this may prevent the user from successfully using the corresponding service.

IP-based devices that are currently available in the market do not provide any indication to the user as to potential problems that may prevent the user from using a service. It would be advantageous for a user to have information in addition to link-level capability so that the user could ascertain whether a service is available or what quality of service can be expected. Accordingly, a need exists for a method and apparatus for use in IP-based devices that provide an indication to the user that informs the user of issues that are relevant to the user's ability to successfully use the service.

### SUMMARY OF THE INVENTION

The invention provides a method and an apparatus for use in an Internet Protocol (IP)-based device for conveying information to a user relating to conditions that may affect use of an IP service by the user. The apparatus comprises a user interface and a processor. The user interface has one or more indicators that can be varied to provide an indication to a user as to conditions that may affect use of a service by the user. The processor is configured to acquire and process information relating to conditions that may affect the call. The processor controls the indicator or indicators in accordance with the processed information.

The method comprises acquiring information relating to conditions that may affect use of an IP service by a user, processing the acquired information to ascertain the meaning to be associated with the acquired information, and varying one or more indicators of a user interface of the device to convey information to a user of the device as to conditions that may affect use of the IP service by the user.

The invention also provides a software program embodied on a computer-readable medium. The program comprises instructions acquiring information relating to conditions that may affect use of an IP service by a user of an IP-based device over a network, instructions for processing the acquired information to ascertain the meaning to be associated with the acquired information, and instructions for causing one or more indicators of a user interface of the device to be varied to convey information to a user of the device as to conditions that may affect use of the service.

These and other features and advantages of the invention will become apparent from the following description, drawings and claims.

### BRIEF DESCRIPTION OF THE DRAWINGS

FIG. 1 illustrates a pictorial diagram that demonstrates the connections between a first IP-based end user device 1 and an IP-based network, and between a second IP-based end user device 2 and the IP-based network.

FIG. 2 illustrates a front view of an indicator portion of the IP-based end user device shown in FIG. 1.

FIG. 3 illustrates a block diagram of the IP-based end user device shown in FIG. 1.

FIG. 4 illustrates a flowchart that represents the method of the invention in accordance with an exemplary embodiment for obtaining CP information and for conveying the CP information to a user through one or more indicators of an IP-based end user device.

### DETAILED DESCRIPTION OF THE PREFERRED EMBODIMENT

The IP-based device of the invention is provided with one or more indicators that inform the user of issues relevant to conditions that may affect use an IP service by a user of an IP-based device. Such information includes, for example, network component ports that are and are not open, IP addresses that are and are not available, call signaling anomalies, bandwidth availability, network congestion, packet loss, delay, jitter, packet misordering, packet repetition, account status, etc. The information relating to issues such as bandwidth availability, network congestion, packet loss, delay, jitter, packet misordering, and packet repetition is commonly classified in the art as quality of service (QoS) information.

The invention is not limited to the information described above, but applies to any information that may affect use of a service by a user of an IP-based device. All such information will be referred to herein as “service-affecting” information, or “S-A” information.

The term “IP-based network”, as that term is used herein, is intended to denote any packet-based network that uses the IP communications protocol or a similar communications protocol as the basis for communication over the network. The term “IP service”, as that term is used herein, is intended to denote any services that are currently available over IP-based networks, including, but not limited to placing, receiving and participating in a voice call using an IP telephony system, receiving an audio file from a streaming audio server, receiving an audio/video (A/V) file from a streaming A/V server, downloading a text file from a server, sending and receiving email messages, performing searches using search engines, using a video telephony system, as well as services that may become available in the future. Use of such services may involve the use of various protocols such as, for example, Voice Over Internet Protocol (VoIP), Voice and Video Over Internet Protocol (V2oIP), Internet Protocol Television (IPTV), Internet Radio, etc. The term “service provider”, as that term is used herein, is intended to denote any provider of an IP service.

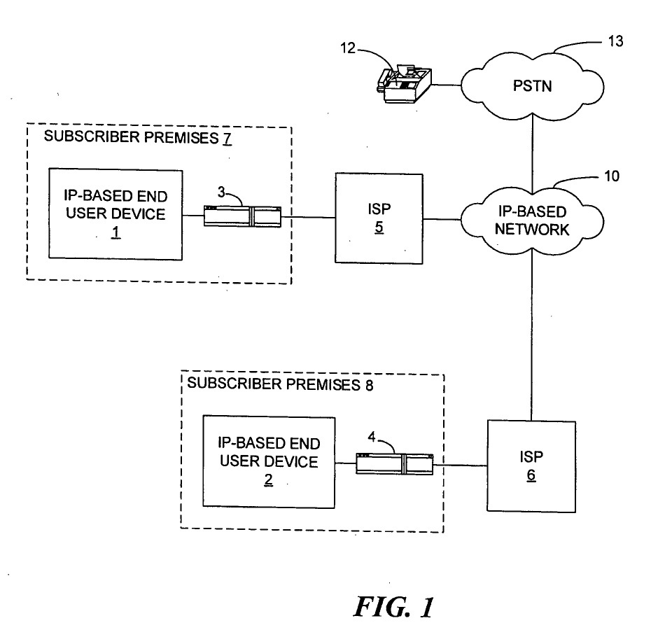

FIG. 1 illustrates a pictorial diagram that demonstrates the connections between a first IP-based end user device 1 and an IP-based network 10, and between a second IP-based end user device 2 and the IP-based network 10. The first and second IP-based end user devices 1 and 2 are connected to respective routers 3 and 4, which are connected to respective ISPs 5 and 6. The first IP-based end user device 1 is located at a subscriber's premises 7. The second IP-based end user device 2 is located at a subscriber's premises 8. A call placed by the IP-based end user device 1 may be, for example, a call to IP-based end user device 2, a request for a service sent to a server (not shown) in the IP-based network 10 that provides some service (e.g., a subscription-based streaming audio server), a call to a plain old telephone service (POTS) device 12 connected to a Public Switched Telephone Network (PSTN) 13, etc.

The first IP-based end user device 1 is configured with functionality that enables it to obtain S-A information and to activate one or more indicators of the IP-based end user device 1 in accordance with the obtained service information. The S-A information may relate to, for example, connectivity information associated with the router 3, connectivity information associated with one or more components of the ISP 5, account status information associated with the end user's account with the ISP 5, connectivity information associated with one or more components in the IP-based network 10, account status information associated with an account the end user has with a service provided within the IP-based network, connectivity information associated with one or more components of the ISP 6, and connectivity information associated with the router 4 and end user device 2 located at the subscriber's premises 8. Other service-affecting information may also be acquired and used to activate one or more indicators of the IP-based end user device.

The IP-based end user device may be any type of IP-based device including, for example, an IP telephone, a video telephone, an IP camera, a set top box, a cellular telephone, or any other type of device that is capable of using an IP service or the like. Certain types of S-A information is currently capable of being obtained by known protocols. For example, the Interactive Connectivity Establishment (ICE) format and protocol enables information regarding WAN connectivity to be obtained. The IP-based device of the invention may be configured to include ICE capability in order to enable the IP-based device to obtain WAN connectivity information, which the IP-based device would then use to activate and/or control one or more indicators of the IP-based device. Other information that is currently capable of being obtained includes packet loss measurement data, bandwidth availability measurement data and port availability data.

Other types of S-A information may be “discovered” by the IP-based device 1 of the invention. A protocol called Internet Control Message Protocol (ICMP) may be used to “ping” network components in order to obtain connectivity information, such as WAN and Internet connectivity information. It should be noted, however, that the invention is not limited to using any particular tools, protocols, mechanisms, etc., to obtain S-A information.

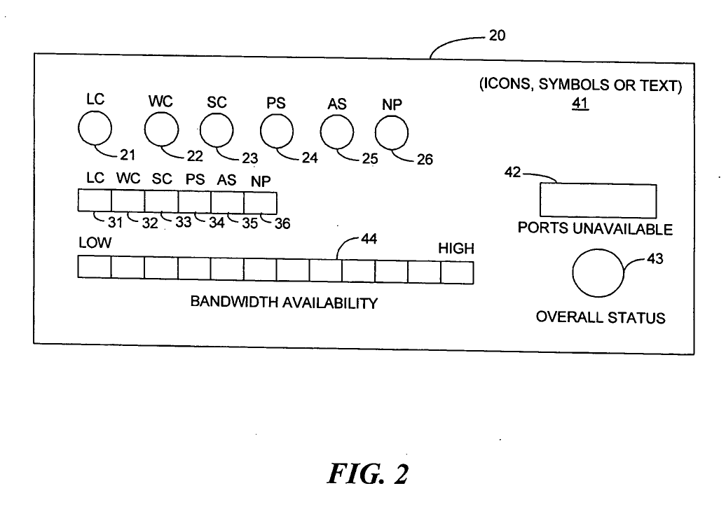

FIG. 2 illustrates a front view of an indicator portion 20 of the IP-based end user device 1 shown in FIG. 1. The indicator portion 20 may include various types of indicators including, for example, light emitting diodes (LEDs) 21-26 that light in progression and/or change from one color to another as service use conditions change or are confirmed, a horizontal (or vertical) bar having segments 31-36 that light and darken in sequence as service use conditions change or are confirmed, icons, symbols or text 41that are displayed to reflect current service use conditions, a box 42 that displays port numbers that are unavailable, an overall network health status LED 43 that is green when the overall health of the network is “good” and red when the overall health of the network is “poor”, a horizontal (or vertical) bar 44 having segments that light and darken in sequence as bandwidth availability increases and decreases.

It should be noted that the indicators shown in FIG. 2 are merely examples of possible indicators that can be used to convey the desired information to the user. Those skilled in the art will understand, in view of the description provided herein, that a variety of different types of indicators may be used for this purpose. The invention is not limited to any particular types of indicators or with respect to the types of information that the indicators convey.

In the indicator portion shown in FIG. 2, the LEDs 21-26 change from a lighted state to and darkened state, and vice versa, and/or change color (e.g., from yellow to green, and vice versa), in accordance with the current service use conditions associated with the LEDs 21-26. For example, when LAN connectivity is established, the LED 21 labeled LC may change from a darkened state to a lighted state. Alternatively, the LED 21 may change color, e.g., from yellow to green, when LAN connectivity is established. Then, while LAN connectivity remains established and WAN connectivity becomes established, the WC LED 22 may change from a darkened state to a lighted state, or from yellow to green, for example. The indicators 23-26 represent, respectively, service connectivity and authorization (SC), provisioning success (PS), account status (AS), and network parameters (NP) such as congestion, impairment, packet loss, bandwidth. The indicators 23-26 will change state in the same way as indicators 21 and 22 change state as conditions change.

Thus, when all of the indicators 21-26 are in the lighted state, this provides a visual indication to the user that the network components that are needed in order to use a service are all functioning properly. It should be noted that the indicators 21-44 not only provide information to the user when a service is being used, but preferably at all times so that a user is able to ascertain whether a service will be available as well as the quality of service that the user can expect to experience.

The horizontal bar having segments 31-36 provides the same information as provided by indicators 21-26, but in a different way. The bar segments 31-36 change from a darkened state to a lighted state, and vice versa, to indicate the current conditions. Only one set of the indicators 21-26 or 31-36 is needed, although both may be included. Icons, symbols or text, which are collectively represented by numeral 41 may be provided in addition to, or in lieu of, the indicators 21-26 and 31-36. The icons, symbols or text 41 may provide visual indications of all of the conditions described above as well as others.

A box 42 may be provided that displays numbers of ports that are currently unavailable. The LED 43 may, for example, change from a lighted state to a darkened state, and vice versa, or from one color to another, to indicate the overall effect of conditions on one or more services. This may be useful in cases in which the precise problem cannot be determined, but the service cannot be used. This may also be useful in cases when there are more problems than the individual indicators are capable of adequately conveying. LED 43 may change from green to red when this occurs. The LED 43 may provide an overall QoS visual indication. It should also be noted that while then invention is being described with reference to visual indicators, one or more auditory indicators may also be used to convey the desired information to the user.

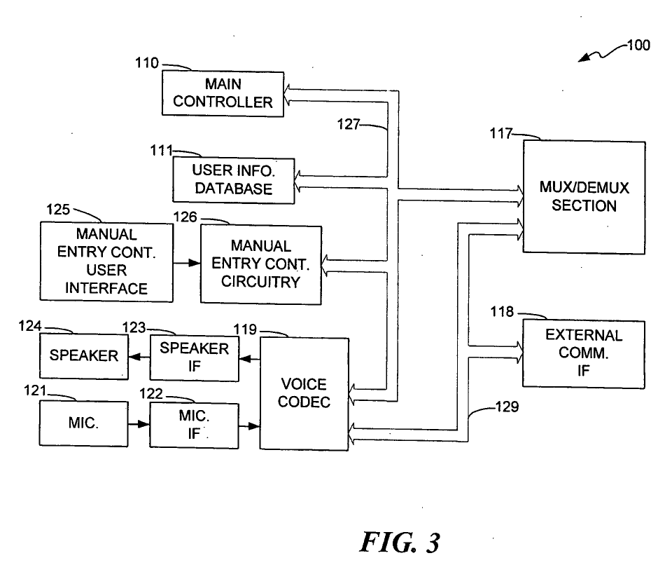

FIG. 3 illustrates a block diagram of the IP-based end user device 1 shown in FIG. 1. In this exemplary embodiment, the IP-based end user device 1 is an IP telephony system. The system 100 comprises a main controller 110, a personalized user information database 111, a multiplexing and separating section 117, an external communications interface 118, a voice codec 120, a microphone 121, a microphone interface 122, a speaker interface 123, a speaker 124, a user interface control portion 125, and a user interface control circuit portion 126. The user interface control portion 125 typically includes a telephone handset, a display device, and/or other user interface components (e.g., a touchscreen) that allow the user to properly use the IP telephony system 100. Of course, other interfaces and interface components that are not shown may also be incorporated into the system 100, such as, for example, Universal Serial Bus (USB), Bluetooth and cordless handset interfaces, etc.

The main controller 110, the personalized user interface database 111, the multiplexing and separating section 117, the communications interface 118, the voice codec 120, and the manual entry control circuit portion 126 are connected together via a main bus 127. The multiplexing and separating section 117, which manages the incoming and outgoing audio data to and from the external communications network, is connected with the communications system interface 118 and the voice codec 119 via buses 127 and 129, respectively. The main controller 110 typically includes a CPU, a ROM, a RAM, and so on. The operations of the various portions of the telephony system 100 are under control of the main controller 110. The main controller 110 performs various functions in software according to data stored in the ROM, RAM, and personalized user information database 111.

The personalized user information database 111 is used to store a database of information for each registered user. Each database is composed of plural records. Each record may comprise, for instance, a personal phonebook (including, e.g., a phone book memory number, a phone number, a name, a home address, a business address, an email address, and any other appropriate information), and/or personal ringtone(s), alerts, screensavers, call logs, buddy lists, journals, blogs, and web sites or other preferences. When retrieved, the personal phonebook may be presented to the user on a display of the manual entry control user interface 125.

The multiplexing and demultiplexing portion 117 demultiplexes encoded audio data, and other data from the transmitted data supplied from the communications interface 118 via the sync bus 129. The multiplexing and demultiplexing portion 117 supplies the demultiplexed data to the main controller 110 via bus 127.

The external communications interface 118 is used to make a connection to the external communications network, which, as previously mentioned, may be any suitable network such as, but not limited to, a wireless network, a conventional telephone network, a data network (e.g., the Internet), and a cable modem system. The interface 118 makes various calls for communications via the communications network and sends and receives voice and video data via communications paths established in the network. In the exemplary embodiment represented by FIG. 1, the interface 118 includes a broadband connection (e.g., Ethernet) that is connected to the router 3 shown in FIG. 1.

The voice codec 119 digitizes analog audio signals applied via the microphone 121 and the microphone interface 122. The codec 119 encodes the signal by a given audio encoding method such as, for example, ADPCM to create encoded audio data, and sends the encoded audio data to the multiplexing and demultiplexing portion 117 via the sync bus 129. The voice codec 119 decodes the encoded audio data supplied from the multiplexing and demultiplexing portion 117 into an analog audio signal, which is supplied to the speaker interface 123.

The microphone 121 converts sound from the surroundings into an audio signal and supplies it to the microphone interface 122, which, in turn, converts the audio signal supplied from the microphone 121 into a signal form that can be processed by the voice codec 119 and supplies it to the voice codec 119. The speaker interface 123 converts the audio signal supplied from the voice codec 119 into a signal form capable of being processed by the speaker 124, and supplies the converted signal to the speaker 124. The speaker 124 converts the audio signal supplied from the speaker interface 123 into an audible signal at an increased level.

The manual entry control user interface 125, which preferably is a graphical user interface (GUI), receives various instructions input by the user to be performed by the main controller 110. The interface 125 preferably includes control buttons for specifying various functions, push buttons for entering phone numbers and various numerical values, and a power switch for turning on and off the operation of the present terminal. The manual entry control circuitry 126 recognizes the contents of an instruction entered from the manual entry control user interface 125 and informs the main controller 110 of the contents of the instruction. The main controller 110 then causes the corresponding functions to be performed.

As stated above, the user interface 125 includes a display that displays information of the type described above with reference to FIG. 2. The main controller 110 is programmed to execute one or more software computer programs that enable the system 100 to obtain the CP information, and to operate the indicators of the user interface 125 in a way that conveys the corresponding information to a user. In addition to displaying the CP information visually, CP information may by provided to the user via codec 119, speaker interface 123 and speaker 124.

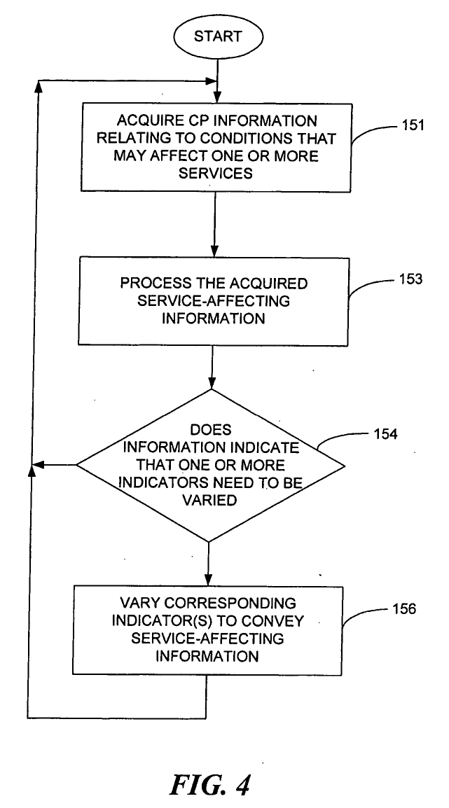

FIG. 4 illustrates a flowchart that represents the method of the invention in accordance with an exemplary embodiment for obtaining S-A information and for conveying the S-A information to a user via one or more indicators of an IP-based end user device. The IP-based device acquires S-A information relating to whether a call placed by an IP-based device over a network will be successful, as indicated by block 151. The information is processed to produce one or more control signals that control the indicators, as indicated by block 153. A determination is made as to which indicator or indicators are to be varied (e.g., changed from a darkened state to a lightened state, changed from one color to another, etc.), as indicated by block 154. If no indicators need to be varied, the process returns to block 151 and continues through the loop represented by blocks 151, 153 and 154. If a determination is made at block 154 that one or more indicators are to be varied, the corresponding indicator or indicators are varied, as indicated by block 156.

The determination process represented by block 154 may not be necessary. Rather than making the determination represented by block 154, the indicators could simply be varied in accordance with the acquired information. If the acquired information does not represent a change in conditions, the control signals applied to the indicators will not change values, and thus the corresponding indicators will not be varied. Therefore, the indicators could simply be varied in accordance with the processed information.

The algorithm represented by the flowchart may be carried out on a continuous basis or periodically. Also, the algorithm may be performed for each different type of S-A information or for each different type of indicator, in which case multiple instances of the algorithms represented by the flowchart may be performed simultaneously. The algorithms are typically implemented by one or more software programs, which that are executed by the main controller 110. However, the algorithms may be performed solely in hardware or in a combination of hardware and software or firmware.

The main controller 10 may be any type of processor including, for example, a microprocessor, a microcontroller, an application specific integrated circuit (ASIC), a programmable logic or gate array (e.g., PLAs, FPGAs, etc.). One or more of these algorithms may be performed by one or more other processors (not shown) that may be incorporated into the system 100. The term “processor” is used herein to denote any of these and other computational devices that can be suitably configured to perform these corresponding functions.

The software programs described above may be embodied in any type of computer-readable medium such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats.

It should be noted that the invention has been described with reference to particular embodiments, and that the invention is not limited to the embodiments described herein. Those skilled in the art will understand that many modifications may be made to the embodiments described herein and that all such modifications are within the scope of the invention.

What is claimed is:

1. An apparatus for use in an Internet Protocol (IP)-based device for conveying information to a user of the device as to conditions that may affect use of an IP service by a user of the IP-based device, the apparatus comprising:
a user interface having one or more indicators that can be varied to provide an indication to a user as to conditions that may affect use of an IP service by a user of the IP-based device; and
a processor configured to acquire and process information relating to conditions that may affect use of the service by the user of the user of the IP-based device, the processor controlling said one or more indicators in accordance with the processed information such that said one or more indicators convey information to the user regarding conditions that may affect use of the service by the user of the IP-based device.

2. The apparatus of claim 1, wherein at least one of said one or more indicators conveys information relating to local area network (LAN) connectivity.

3. The apparatus of claim 1, wherein at least one of said one or more indicators conveys information relating to wide area network (WAN) connectivity.

4. The apparatus of claim 1, wherein at least one of said one or more indicators conveys information relating to service provider connectivity.

5. The apparatus of claim 1, wherein at least one of said one or more indicators conveys information relating to provisioning success.

6. The apparatus of claim 1, wherein at least one of said one or more indicators conveys information relating to status of an account.

7. The apparatus of claim 1, wherein at least one of said one or more indicators conveys information relating to available bandwidth.

8. The apparatus of claim 1, wherein at least one of said one or more indicators conveys information to network congestion.

9. The apparatus of claim 1, wherein the network is the Internet.

10. The apparatus of claim 1, wherein the IP-based device is an IP telephony system.

11. The apparatus of claim 1, wherein the IP-based device is a video telephony system.

12. The apparatus of claim 1, wherein the IP-based device is a camera.

13. The apparatus of claim 1, wherein the IP-based device is a set top box.

14. A method for use in an Internet Protocol (IP)-based device for conveying information to a user of the device as to conditions that may affect use of a service by a user of the IP-based device, the method comprising:
acquiring information relating to conditions that may affect use of an IP service by a user of an IP-based device;
processing the acquired information to ascertain a meaning to be associated with the acquired information; and
varying one or more indicators of a user interface of the device to convey information to a user of the device as to conditions that may affect use of an IP service by a user of an IP-based device.

15. The method of claim 14, wherein at least one of said one or more indicators conveys information relating to local area network (LAN) connectivity.

16. The method of claim 14, wherein at least one of said one or more indicators conveys information relating to wide area network (WAN) connectivity.

17. The method of claim 14, wherein at least one of said one or more indicators conveys information relating to service provider connectivity.

18. The method of claim 14, wherein at least one of said one or more indicators conveys information relating to provisioning success.

19. The method of claim 14, wherein at least one of said one or more indicators conveys information relating to status of an account.

20. The method of claim 14, wherein at least one of said one or more indicators conveys information relating to available bandwidth.

21. The method of claim 14, wherein at least one of said one or more indicators conveys information to network congestion.

22. A computer program for use in an Internet Protocol (IP)-based device for conveying information to a user of the device as to an ability of the device to place a call over a network, the program comprising instructions for execution by a computer, the program being embodied in a computer-readable medium, the program comprising:
instructions for acquiring information relating to conditions that may affect use of an IP service by a user of an IP-based device;
instructions for processing the acquired information to ascertain a meaning to be associated with the acquired information; and
instructions for causing one or more indicators of a user interface of the device to be varied in accordance with the processed information to convey information to a user of the device as to conditions that may affect use of an IP service by a user of an IP-based device.
